(19) United States
(12) Patent Application Publication
(10) Pub. No.: US 2008/0222634 A1
(43) Pub. Date: Sep. 11, 2008

(54) PARALLEL PROCESSING FOR ETL PROCESSES

(75) Inventor: Amit Rustagi, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/682,815

(22) Filed: Mar. 6, 2007

(51) Int. Cl. G06F 9/46

(52) U.S. Cl. 718/100

(57) ABSTRACT

A technique for parallel processing of data from a plurality of data sources in conjunction with an Extract-Transform-Load (ETL) process, the data being part of a related data set, which comprises the following: staging a unit of extracted data from each of the plurality of data sources, thereby generating a plurality of units of staged data; identifying a plurality of tasks relating to transforming the staged data; assigning a subset of the tasks to each of a plurality of child processes being managed by a master process, such that dependent tasks are assigned to a same child process; concurrently executing the subsets of tasks assigned to the child processes, thereby generating a plurality of units of transformed data from the plurality of units of staged data; and publishing the transformed data after all tasks are completely executed, thereby ensuring that the published data represent the related data set.

### BACKGROUND OF THE INVENTION

1. Field of the Invention

The present invention relates to parallel processing of staged data extracted from multiple data sources within the framework of Extract-Transform-Load processes.

2. Background of the Invention

An extract, transform, and load (ETL) process is a data warehousing process that involves three steps: (1) extracting data from one or more data sources; (2) transforming the extracted data to fit various business needs; and (3) loading the transformed data into one or more data warehouses. Often, businesses have valuable data scattered throughout their networks, databases, business applications, etc. It would be difficult to analyze these data and obtain meaningful results unless these data are cleansed, formatted, and centralized. An ETL process provides a solution to this problem by extracting the relevant data from all types of sources, cleansing, formatting, and organizing the data according to the specific requirements of a particular business, and loading the processed data into a central repository, such as a data warehouse or a database. Thereafter, the data may be analyzed in parts or as a whole to provide various types of useful information to the business.

Because data are extracted from different types of sources, it is possible that these data sources provide data at different speeds. For example, it may take longer for some data sources to gather the necessary data and make the data available for extraction. If a specific analysis is to be performed on related data extracted from multiple sources, the analysis should not begin until all related data are extracted and transformed. Conventional ETL processes do not typically provide any means to ensure that all related and relevant data are available before an analysis performed on these data begins. Instead, data are extracted, transformed, and loaded into the data warehouses and thus published as they become available. A user, who wishes to perform an analysis on multiple units of related data, has no way of determining whether all units of related data are available in the data warehouses.

Accordingly, what is needed are systems and methods which ensure that an analysis is performed on the complete data set.

### SUMMARY OF THE INVENTION

Broadly speaking, the present invention relates to parallel processing of data extracted from multiple data sources and publishing the resulting transformed data when all transformed data are available.

In one embodiment, a computer-implemented method for parallel processing of data generated by an Extract-Transform-Load (ETL) process, the data being part of a related data set, is described. A unit of extracted data is staged from each of a plurality of data sources, thereby generating a plurality of units of staged data. A plurality of tasks for transforming the plurality of units of staged data are identified. A subset of the tasks is assigned to each of a plurality of child processes being managed by a master process, such that dependent tasks are assigned to a same child process. The subsets of tasks assigned to the child processes are concurrently executed, thereby generating a plurality of units of transformed data from the plurality of units of staged data. The plurality of units of transformed data is published after all tasks from the plurality of tasks are completely, thereby ensuring that the published data represent the related data set.

In another embodiment, a system for parallel processing of data in conjunction with an ETL process is described. A plurality of data sources is operable to generate the data, and the data are part of a related data set. At least one data store is operable to store published data generated by the ETL process. At least one computing device is configured to stage a unit of extracted data from each of the plurality of data sources, thereby generating a plurality of units of staged data; identify a plurality of tasks for transforming the staged data; assign a subset of the tasks to each of a plurality of child processes being managed by a master process, such that dependent tasks are assigned to a same child process; concurrently execute the subsets of tasks assigned to the child processes, thereby generating a plurality of units of transformed data from the plurality of units of staged data; and publish the transformed data to the at least one data store after all of the plurality of tasks are completed, thereby ensuring that the published data represent the related data set.

In another embodiment, a computer program product for parallel processing of data from a plurality of data sources in conjunction with an ETL process, the data being part of a related data set, is described. The computer program product comprises a computer-readable medium having a plurality of computer program instructions stored therein. The computer instructions are operable to cause at least one computer device to: stage a unit of extracted data from each of the plurality of data sources, thereby generating a plurality of units of staged data; identify a plurality of tasks for transforming the staged data; assign a subset of the tasks to each of a plurality of child processes being managed by a master process, such that dependent tasks are assigned to a same child process; concurrently execute the subsets of tasks assigned to the child processes, thereby generating a plurality of units of transformed data from the plurality of units of staged data; and publish the transformed data to at least one data store after all of the plurality of tasks are completed, thereby ensuring that the published data represent the related data set.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an example of a system that processes the extracted data in serial within the framework of ETL processes.

FIG. 2 is a block diagram illustrating an example of a system that processes the extracted data in parallel within the framework of ETL processes.

FIG. 3 is a flowchart of a method for processing the extracted data in parallel within the framework of ETL processes.

FIG. 4 is a simplified diagram of a network environment in which specific embodiments of the present invention may be implemented.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

An extract, transform, and load (ETL) process is a data warehousing process that consolidates data from multiple sources, which often store data in different formats, into a centralized repository, such as a data warehouse, a data mart, or a database. First, data are extracted from one or more sources of various types, such as web logs, mainframe applications, spreadsheets, message queues, etc. Next, during the transform phase, a series of rules or functions are applied to the extracted data to cleanse, reformat, and reorganize the extracted data. Business functions and rules may also be applied to the extracted data. Data transform may be performed in stages. In other words, a set of rules or functions may be applied to the extracted data, followed by another set of rules or functions being applied to the same data. Sometimes, the transformed data are referred to as “data feed.” During the load phase, the transformed data are loaded into one or more data warehouses, data marts, or databases. A data warehouse is typically a repository of historical data of an entity such as a corporation or an organization.

Once the transformed data are loaded into data warehouses, they are accessible to the intended audience (e.g., the business users of a corporation)—that is, they are published. Thereafter, users may access these data for various purposes, such as analyzing them for specific business needs. For example, a business entity may analyze the data stored in its warehouse to determine which types of products are more popular among its customers. Such analysis may be helpful in planning the business' future marketing strategies.

Sometimes, related data needed for a specific analysis may come from multiple data sources that provide data at different speeds. For example, assume a business sells books on the Internet, in stores, and through telephone call centers. This means a buyer has three options when buying a book. The buyer may order the book online via the business's website, purchase the book by visiting a local store, or order the book by calling the business on the telephone. At the end of each month, the business may wish to determine the total sales amount for that month from all of these channels. Thus, the business needs to gather sales data from its website, each of its stores, and its call centers in order to have the complete sales figure. Unfortunately, not all sources provide the required data at the same speed. The website may have its sales data fairly quickly because all purchase orders throughout the month are processed and tracked by a computer program automatically. The call centers may take longer time to collect the sales data because the purchase orders need to be entered into the computer system by the telephone operators. The stores may take even longer time to collect their sales data because in-store purchases are often processed manually.

Nevertheless, a monthly sales analysis is meaningless unless all sales data from all possible channels are available and taken into account. Therefore, the business needs to wait until the monthly sales figures from its website, all of its stores, and its call centers are completely loaded into its data warehouse before beginning its monthly sales analysis.

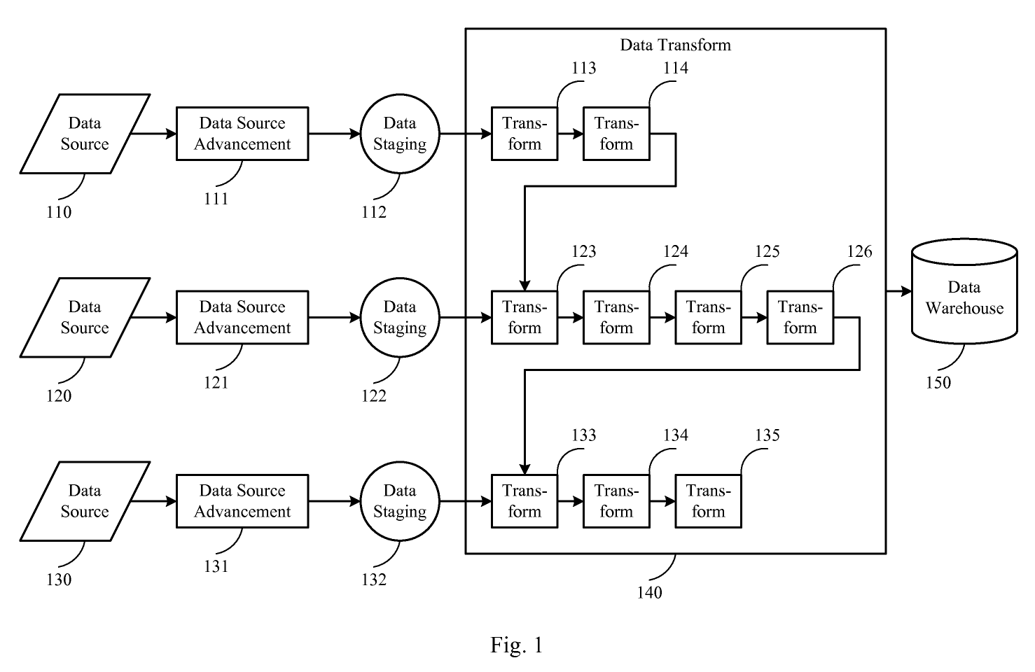

FIG. 1 is a block diagram illustrating an example of a system that processes the extracted data in serial within the framework of one or more ETL processes to ensure that related data from multiple sources are available for a specific analysis. As will be understood, “related data” refers to any arbitrarily defined data set which, if incomplete, would result in inaccurate results of analyses conducted on the data set. The example of monthly sales figures is described above. In that example, one of the primary metrics by which data are considered related is a time period (e.g., sales in a particular month). That is, the related data set includes monthly sales figures from multiple sales channels (store, website, call center, etc.). It will be understood that this is merely one example and that there is a wide variety of metrics that may be used to define related data including, but not limited to, periods of time, geographic regions, customer demographic information, product information, etc., or any combination of such metrics. In other words, related data sets can be defined based on any user requirements. FIG. 1 shows three data sources: Data Source 110, Data Source 120, and Data Source 130. Each data source 110, 120, 130 supplies a unit of data that is a part of a bigger data set required for a specific analysis. Thus, before the analysis may proceed, data from all data sources 110, 120, 130 need to be available.

Data Source 110, Data Source 120, and Data Source 130 may supply their respective units of data at different times—that is, one data source may supply its unit of data before another data source. One way to ensure that all data are available for analysis is to wait until data from all data sources 110, 120, 130 are available before they are transformed and published. According to one approach, the system repeatedly checks whether data from each data source 110, 120, 130 has advanced. Data source advancement means data from a given source is available for a given time period. If data from a particular source has advanced, the system marks that source as having advanced. Thereafter, only un-advanced sources need to be checked. The system waits until all data sources have advanced.

For example, assume data from Data Source 120 become available first. Thus, Data Source 120 has advanced 121. The system marks Data Source 120 as having advanced and no longer checks it. Thereafter, the system only checks the un-advanced data sources 110, 130. Assume data from Data Source 110 become available next. Thus, Data Source 110 has advanced 111. The system marks Data Source 110 as having advanced. Thereafter, the system only checks the un-advanced Data Source 130. Assume finally data from Data Source 130 become available. Thus, Data Source 130 has also advanced 131. The system marks Data Source 130 as having advanced. At this point, data from all sources 110, 120, 130 are available and have advanced. The system is ready to process the advanced data.

According to one approach, a temporary storage is used to store the advanced data until they are ready to be transformed. Each data source 110, 120, 130 may extract and store its respective unit of data in the temporary storage when that unit of data becomes available. This step is sometimes referred to as “data staging.” A staging schema may be used to indicate where and how each data source 110, 120, 130 may store its unit of data in the temporary storage. For example, a staging schema may be a table that indicates which unit of data is stored at what location. Subsequently, staging schema may also be used to help retrieve specific units of stored data. Thus, continuing with the above example, when data from Data Source 120 become available, they are extracted and stored in the temporary storage, or staged 122. Similarly, when data from Data Source 110 and Data Source 130 become available, they are also staged in the temporary storage 112, 132.

Data sources 110, 120, 130 may only store their data in the temporary storage, which is not available to be accessed by the intended audience of users. In other words, staged data are not published. This prevents users from using the staged data before all related data become available and are completely processed.

Once data are extracted from their respective sources, the next step in the typical ETL process is to transform them 140 according to specific business requirements. As explained above, transformation of a specific unit of data may be done in stages. For example, as shown in FIG. 1, data from Data Source 110 are transformed in two stages 113, 114; data from Data Source 120 are transformed in four stages 123, 124, 125, 126; and data from Data Source 130 are transformed in three stages 133, 134, 135. Each stage of transformation cleans, organizes, summarizes, categorizes, or applies business rules to the data being transformed.

According to one approach, the transformation may be done in serial. That is, the system may perform the two transformations for data from Data Source 110 (stage 1 transformation 113 followed by stage 2 transformation 114), followed by the four transformations for data from Data Source 120 (stage 1 transformation 123 followed by stage 2 transformation 124 followed by stage 3 transformation 125 followed by stage 4 transformation 126), followed by the three transformations for data from Data Source 130 (stage 1 transformation 133 followed by stage 2 transformation 134 followed by stage 3 transformation 135).

At this point, all related data are available and transformed. The system may load the data into Data Warehouse 150 and make the data available to be accessed by the users—that is, publishing the data. A population schema may be used to indicate how each unit of transformed data may be stored in Data Warehouse 150. Because data are not published until all related data are available and transformed, this ensures that users have the complete set of data for analysis.

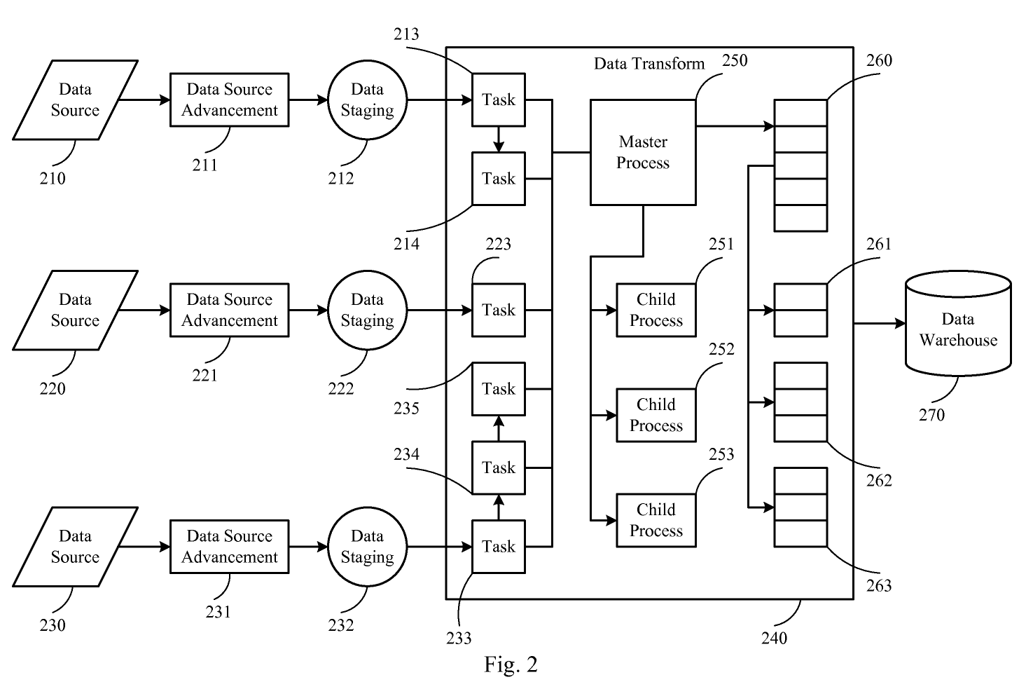

The system in FIG. 1 processes the staged data in serial, performing one stage of transformation for one unit of data at a time. This may take a long time, especially when there are a large number of data sources supplying many units of data. To improve efficiency, FIG. 2 illustrates an example of a system implemented according to a specific embodiment of the invention that processes the extracted data in parallel within the framework of one or more ETL processes to ensure that related data from multiple sources are available for a specific analysis. FIG. 2 again shows three data sources: Data Source 210, Data Source 220, and Data Source 230. However, the system is not limited to any specific number of data sources. Instead, the same concepts apply whether there are three, thirty, three hundred, or any other number of data sources.

Using the above example, Data Source 210 may be the book merchant's website, Data Source 220 may be a call center, and Data Source 230 may be a store. Each data source 210, 220, 230 supplies a portion of related data (monthly sales figures from each channel) that together form a complete set of data (monthly sales figures from all channels) to be used for a particular analysis (total monthly sales amount of the business). The monthly sales figures for the current month may become available first from Data Source 210 (the website), then from Data Source 220 (the call center), and finally from Data Source 230 (the store).

According to one embodiment, the system waits until data from all sources 210, 220, 230 are advanced. The system repeatedly checks whether data from each data source 210, 220, 230 are available. If data from a particular source is available, the data are advanced 211, 221, 231 and stored in a temporary storage 212, 222, 232, and that data source is marked as “advanced.” Subsequently, the system only checks un-advanced sources, until all data sources 210, 220, 230 have advanced.

Once data from all data sources 210, 220, 230 have advanced, the system processes the data in parallel 240, which involves transforming each unit of data advanced and extracted from data sources 210, 220, 230 according to some predefined business logic. For example, assume that data extracted from Data Source 210 (staged data 212) requires a two-stage transformation: the first stage cleanses the data (task 213) and the second stage summarizes the data (task 214); data extracted from Data Source 220 (staged data 222) requires a one-stage transformation: to reformat the data (task 223); and data extracted from Data Source 230 (staged data 232) requires a three-stage transformation: to cleanse (task 233), reformat (task 234), and summarize the data (task 235). Thus, completely processing all data involve the following tasks: (1) task 213 cleanses staged data 212; (2) task 214 summarizes staged data 212 after the data are cleansed; (3) task 223 reformats staged data 222; (4) task 233 cleanses staged data 232; (5) task 234 reformats staged data 232 after the data are cleansed; and (6) task 235 summarizes staged data 232 after the data are reformatted.

According to one embodiment, a master process 250 maintains a list of all the tasks 260 needed to be completed. In the above example, the master task list 260 includes the six tasks described.

Among these six tasks, task 214 depends on task 213, because staged data 212 first need to be cleansed (task 213) before they may be summarized (task 214). In other words, task 213 first cleanses the staged data 212 to generate a new unit of cleansed staged data 212, and task 214 takes the cleansed staged data 212 to further generate a new unit of summarized cleansed stage data 212. Therefore, task 214 should not start until task 213 has completed. Similarly, task 235 depends on the result of task 234, which further depends on the result of task 233. Task 235 should not start until task 234 has completed, which should not start until task 233 has completed. On the other hand, task 213, task 223, and task 233 do not depend on any other tasks, and may be started any time.

According to one embodiment, multiple child processes (e.g., processes 251, 252, 253 of FIG. 2) are utilized to execute the tasks concurrently in order to efficiently complete all the tasks involved in transforming the extracted units of data. However, the system is not limited to any specific number of child processes. The number of child processes initiated may depend on the number of tasks to be completed and/or the available processing power and resources in the system. For example, the greater number of tasks, the more child processes may be needed. On the other hand, if the system does not have large processing power, then the system may only be able to support a few child processes.

In the example of FIG. 2, the child processes 251, 252, 253 are managed by Master Process 250. Each child process 251, 252, 253 has its own child task list 261, 262, 263, which contains the tasks assigned to that child process 251, 252, 253 by Master Process 250. Master Process 250 assigns the tasks on the master list 260 to one of the child processes 251, 252, 253, until all tasks are assigned to at least one child process 251, 252, 253.

To ensure that dependent tasks are not started prematurely—that is, before the task it depends is completed, dependent tasks are assigned to the same child process that the task it depends on is also assigned to and in the correct order. Thus, in the above example, task 214 should be assigned to the child process to which task 213 is assigned. Task 234 and task 235 should be assigned to the same child process to which task 233 is assigned and in the right order. Assume task 213 and task 214 are assigned to Child Process 251 in the correct order—that is, task 214 follows task 213. The child task list 261 for Child Process 251 contains two tasks: (1) task 213 cleanses staged data 212; and (2) task 214 summarizes staged data 212. Child Process 251 executing each task on its task list 261 in sequence naturally results in task 213 being executed before task 214.

According to one embodiment, Master Process 250 manages the child processes 251, 252, 253 and monitors their progress. If a child process “dies” without completing the tasks on its task list, the master process 250 has two choices. First, the master process 250 may initiate a new child process to replace the dead child process, and assign the new child process those tasks not yet completed by the dead child process. Alternatively, the master process 250 may assign the remaining tasks to one or more other child processes that are still alive. On the other hand, if Master Process 250 dies before all tasks are completed, all remaining live child processes are terminated, because Master Process 250 manages and monitors all task execution.

According to one embodiment, when assigning tasks to the child processes 251, 252, 253, Master Process 250 attempts to balance the workload among the child processes 251, 252, 253. For example, Master Process 250 may monitor how many tasks are not yet completed for each child process 251, 252, 253 and assign new tasks to the child process with the least number of tasks on its list.

When all tasks on the master task list 260 are completed, all units of related data have been transformed and are ready to be used by the intended users. The processed data may be published so that users may access them for various purposes, such as performing various types of analysis. According to one embodiment, the processed data are loaded into a Data Warehouse 270 and made accessible to the intended audience of users. Because the system ensures that all related data are available before they are published, users are prevented from inadvertently analyzing incomplete data. Again, a population schema may be used to indicate how each unit of transformed data may be stored in Data Warehouse 270.

To ensure efficient execution of all tasks, the system waits until all data from all data sources 210, 220, 230 are available and advanced before performing any transformation on each unit of data. Master Process 250 assembles the master task list 260 only after all units of data from all data sources 210, 223, 230 have advanced and staged. Consequently, tasks are assigned to the child processes 251, 252, 253 to be executed only after all units of data from all data sources 210, 223, 230 have advanced and staged.

The concept of processing the staged data in parallel may be extended to multiple sets of analysis. Often, data sources 110, 120, 130 gather great amount of data relating to different aspects of the business. One type of analysis may only use a portion of the gathered data from each data source 110, 120, 130, while another type of analysis may use a different portion of the gathered data. In the above example, for a monthly sales analysis, the monthly sales figures from each data source 110, 120, 130 are needed. However, at the same time, the business may also be interested in learning about the characteristics of its customers, such as their age, gender, geographic location, etc. in order to plan for targeted advertisement. These data about the customers may also be gathered at each data source 110, 120, 130. Thus, when raw data are extracted from each data source 110, 120, 130, they may include information relating to sales figures, customer characteristics, and many other types of data. In this case, one set of tasks may be directed to preparing sales figures for the monthly sales analysis, while at the same time, another set of tasks may be directed to preparing customer information for the customer characteristic analysis. Both sets of tasks may be processed in parallel.

For example, staged data 112 may include both sales figures for the current month and information about customers who have purchased books from Data Source 110. For the monthly sales analysis, a task may be to select only those data relating to sales figures from staged data 112. For the customer characteristic analysis, a task may be to select only those data relating to customer information also from staged data 112. These two tasks are independent of each and may be executed concurrently. One task may be assigned to one child process, while the other task assigned to another child process. Both child processes may access staged data 112 at the same time.

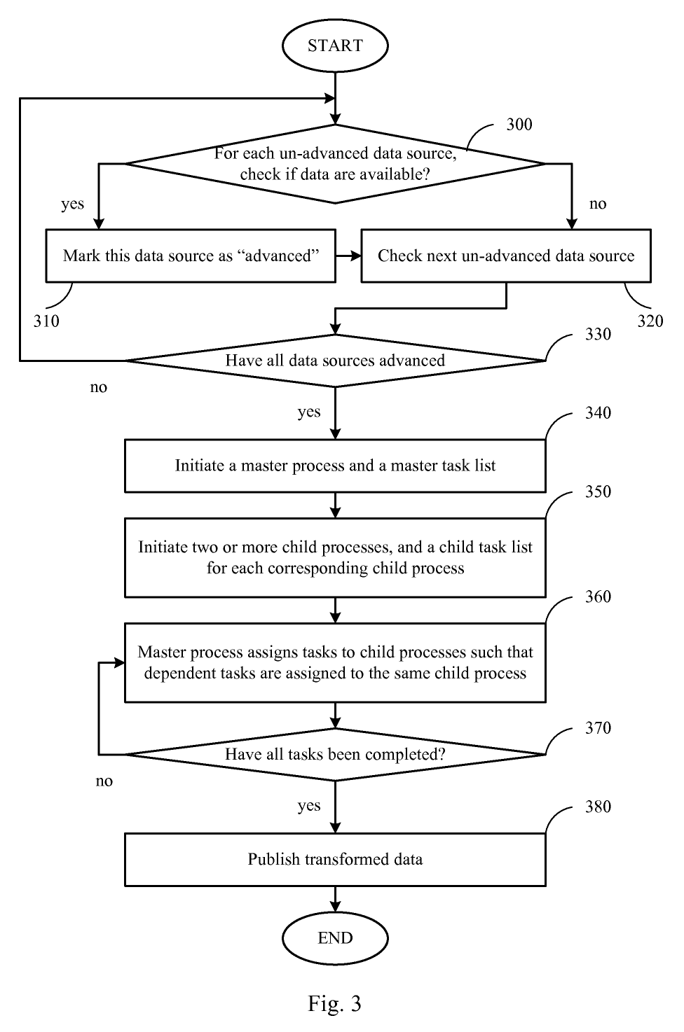

FIG. 3 is a flowchart of a method for processing the extracted data in parallel within the framework of one or more ETL processes. It is one of the methods of operating the system shown in FIG. 2.

At 300, each un-advanced data source is checked to see if data from that data source has become available. If the data from that data source are available, then at 310, that data source is marked as “advanced” and data from that data source may be stored in a temporary storage. Otherwise, if the data from that un-advanced data source are not available, no change is made to that data source and the next un-advanced data source is checked. At 330, a determination is made to determine whether all data sources have been advanced. If at least one data source is not yet advanced, then 300, 310, and 320 are repeated until data from all data sources are extracted and advanced.

As will be understood, 300, 310, 320, and 330 may be implemented as a software program. Assume there are n data sources, an array of n Boolean variables may be used to indicate whether each data source has advanced, with a true value indicating that a particular data source has advanced and a false value indicating that a data source has not yet advanced. The following is a sample of pseudo code that may reflect one specific implementation of the software program:

“advance” is an array of n Boolean variables, with all entries initialized to false;

“done” is a Boolean variable initialized to false, indicating that one or more data sources have not yet advanced;

```
while (done == false) {
  done = true;
  for (i == 0; i < n; i++) {
    if (advance[i] == false) { // only checks un-advanced data source
      if (data from data_source[i] are available) {
          advance[i] = true;
          extract data from data_source[i];
          stage the extracted data from data_source[i];
      } else {
        done = false; // a data source has not advanced
      }
    }
  }
}
```

According to one embodiment, when all data sources have advanced—that is, data from all sources have been staged, at 340, a master process along with a master task list is invoked or instantiated. The master task list is managed by the master process. The master process retrieves predefined transformation rules for each type of staged data and adds the transformation tasks to the master task list. At 350, two or more child processes, each with its own child task list, are invoked or instantiated. The child processes are managed by the master process.

According to one set of embodiments, the main program also monitors whether all related units of data from all data sources have advanced and whether new units of data are becoming available. If not all related units of data are available, then the main program waits and periodically or repeatedly checks for data availability, until all related units of data are available and have advanced. When all related units of data from all data sources have advanced, the main program assembles the master task list as described above and instantiate appropriate number of child processes to execute the tasks.

At 360, the master process assigns tasks on the master task list to each of the child processes to be executed, until at 370 all tasks on the master task list are completed. When assigning tasks, the master process always assigns dependent tasks—that is, a task that depends on the result of another task—to the same child process so that dependent tasks are executed in the correct order (the task that depends on another task is executed after that other task is completed). Also, the master process may attempt to balance the workload of each child process. One way to achieve load balancing is for the master process to keep track of how many tasks have been assigned to each individual child process, and when the master process needs to assign one or more new tasks, the new tasks may be assigned to the child with the least number of unexecuted tasks. Other common methods for load balancing may also be employed.

It will be understood that 340, 350, 360, and 370 may be implemented as a software program. The master process may be the main program, and each child process may be a separate thread. Assuming there are m child processes, then the main program initiates or invokes m threads, one for each child process. Often, when a thread is initiated, it is given a unique identification number (thread ID). Thus, the master process may track all the child processes by their respective unique thread ID.

The master task list may be implemented using a two-dimensional array, with the first dimension representing the number of units of staged data to be transformed and the second dimension representing the individual stages of transformation for each unit of staged data. Thus, dependent tasks for a particular unit of data are grouped together, which makes it easier for the master process to assign dependent tasks to the same child process. Each task may be given a unique identification number so that the master process may track the tasks easily. The following is a sample representation of such a data structure:

| | | | | |
|---|---|---|---|---|
| Staged Data 1 | Task 1a | Task 1b | | |
| Staged Data 2 | Task 2a | | | |
| Staged Data 3 | Task 3a | Task 3b | Task 3c | Task 3d |
| . . . | | | | . . . |
| Staged Data n | Task na | Task nb | Task nc | |

Similarly, each child list may be implemented using a one-dimensional array with the tasks listed in the order of execution. Thus, if task 2 depends on task 1, then task 2 is listed after task 1. Assuming tasks for processing staged data 2 and staged data 3 are assigned to the same child process, the following is a sample representation of such a data structure for that child process:

| | | | | |
|---|---|---|---|---|
| Task 2a | Task 3a | Task 3b | Task 3c | Task 3d |

Alternatively, each child list may also be implemented using either a one-directional or two-directional linked list. The data fields in each node may be used to define an individual task to be executed by the corresponding child process. If a one-directional linked list is used, then the reference of each node points to the next node, which represents the next task to be executed. If a two-directional linked list is used, then the two references point to the previous and next node respectively. The child process executes each task in sequence staring from the beginning of the linked list, and the master process adds each new task in sequence to a child task list at the end of the linked list. Because the tasks are added to the linked list in the order to be executed, a dependent task is executed after the task on which it depends is completed.

As described above, the master process manages and monitors the progress of each child process. When a child process completes execution of a specific task assigned to it, the child process may report to the master of the completion of that task, referring to the task by its unique identification number. This enables the master process to know which tasks have been executed and which have not. The master process may mark completed tasks as being completed on its master task list. This may be implemented by associating a Boolean variable with each task. Before the task is executed, the Boolean value for that task is set to false; after the task is completed, its Boolean value is set to true. Furthermore, since the master process assigns tasks to each child process, the master process also knows which task is assigned to which child process. If a child process dies without completing all the tasks assigned to it, the master process is able to determine which tasks assigned to that child have not been executed by comparing the tasks reported as completed against the tasks assigned to that child process. The master process may assign the tasks not yet completed to another child process that is alive, or initiate a new thread to replace the dead child process and assign the remaining task to the new child process.

On the other hand, if the master process dies due to some error, all remaining child processes need to be terminated. The master process supervises and coordinates the efforts between child processes. Without the master process, there is no coordination between the child processes. Thus, the child processes cannot survive without the master process.

When all tasks on the master task list have been completed, at 380, all units of transformed data are published so that they may be accessed by the intended audience of users. One method is to load the transformed data into a database. Thereafter, users may access the data using appropriate commands suitable for that database. For example, if the database is a relational database, then Structured Query Language (SQL) may be appropriate.

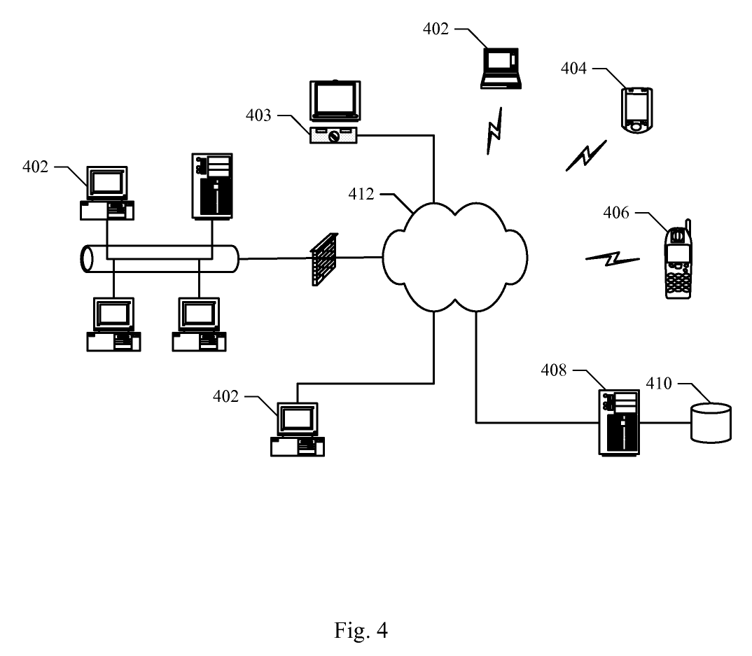

The method described above in FIG. 3 may be carried out, for example, in a programmed computing system. FIG. 4 is a simplified diagram of a network environment in which specific embodiments of the present invention may be implemented. The various aspects of the invention may be practiced in a wide variety of network environments (represented by network 412) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

According to various embodiments, one or more ETL processes may gather data over the network environment 412. People may access the network using different methods, such as from computers 402 connected to the network 412 or from wireless devices 404, 406. Activities from these people generate data that may be gathered by the ETL process for future analysis. The ETL process may be executed on a server 408, and the transformed data are loaded into a data storage unit (data warehouse) 410.

The software program implementing various embodiments may be executed on the server 408. For example, the master process and the child processes may be run on the server 408, which may represent one or more computing platforms. The predefined tasks for each unit of data extracted from multiple data sources may also be stored in the data storage unit 410. After data are processed and loaded into the data warehouse 410, users may access these data via their computers 402, 403, or wireless devices 404, 406.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A computer-implemented method for parallel processing of data from a plurality of data sources in conjunction with an Extract-Transform-Load (ETL) process, the data being part of a related data set, comprising:
staging a unit of extracted data from each of the plurality of data sources, thereby generating a plurality of units of staged data;
identifying a plurality of tasks for transforming the staged data;
assigning a subset of the tasks to each of a plurality of child processes being managed by a master process, such that dependent tasks are assigned to a same child process;
concurrently executing the subsets of tasks assigned to the child processes, thereby generating a plurality of units of transformed data from the plurality of units of staged data; and
publishing the transformed data to at least one data store after all of the plurality of tasks are completed, thereby ensuring that the published data represent the related data set.

2. The method, as recited in claim 1, further comprising:
assigning the tasks to each subset of tasks such that each child process executes approximately a same number of tasks.

3. The method, as recited in claim 1, further comprising for each of the child processes:
monitoring execution of the tasks assigned to the child process; and
if the child process fails to execute all of the tasks assigned to the child process, assigning unexecuted ones of the tasks assigned to the child process to another one of the child processes.

4. The method, as recited in claim 1, further comprising for each of the plurality of child processes:
monitoring execution of the tasks assigned to the child process; and
if the child process fails to execute all of the tasks assigned to the child process, invoking a new child process to replace the child process and assigning unexecuted ones of the tasks assigned to the child process to the new child process.

5. The method, as recited in claim 1, further comprising:
if execution of the master process terminates before completion, terminating execution of all of the child processes.

6. The method, as recited in claim 1, wherein identifying the plurality of tasks begins after all the units of staged data are available.

7. The method, as recited in claim 1, wherein the related data set is defined with reference to at least one metric selected from the group consisting of a period of time, a geographic region, a business entity, a business analysis, a product, and a group of customers.

8. A system for parallel processing of data in conjunction with an ETL process, comprising:
a plurality of data sources operable to generate the data, the data being part of a related data set;
at least one data store operable to store published data generated by the ETL process; and
at least one computing device configured to:
stage a unit of extracted data from each of the plurality of data sources, thereby generating a plurality of units of staged data;
identify a plurality of tasks for transforming the staged data;
assign a subset of the tasks to each of a plurality of child processes being managed by a master process, such that dependent tasks are assigned to a same child process;
concurrently execute the subsets of tasks assigned to the child processes, thereby generating a plurality of units of transformed data from the plurality of units of staged data; and
publish the transformed data to the at least one data store after all of the plurality of tasks are completed, thereby ensuring that the published data represent the related data set.

9. The system, as recited in claim 8, wherein the at least one computing device is configured to identify the plurality of tasks after all the units of staged data are available.

10. The system, as recited in claim 8, wherein the related data set is defined with reference to at least one metric selected from the group consisting of a period of time, a geographic region, a business entity, a business analysis, a product, and a group of customers.

11. The system, as recited in claim 8, wherein the at least one computing device is configured to, for each of the child processes:
monitor execution of the tasks assigned to the child process; and
if the child process fails to execute all of the tasks assigned to the child process, assign unexecuted ones of the tasks assigned to the child process to another one of the child processes.

12. The system, as recited in claim 8, wherein the at least one computing device is configured to, for each of the child processes:
monitor execution of the tasks assigned to the child process; and
if the child process fails to execute all of the tasks assigned to the child process, invoke a new child process to replace the child process and assign unexecuted ones of the tasks assigned to the child process to the new child process.

13. A computer program product for parallel processing of data from a plurality of data sources in conjunction with an Extract-Transform-Load (ETL) process, the data being part of a related data set, the computer program product comprising a computer-readable medium having a plurality of computer program instructions stored therein, which are operable to cause at least one computer device to:
stage a unit of extracted data from each of the plurality of data sources, thereby generating a plurality of units of staged data;
identify a plurality of tasks for transforming the staged data;
assign a subset of the tasks to each of a plurality of child processes being managed by a master process, such that dependent tasks are assigned to a same child process;
concurrently execute the subsets of tasks assigned to the child processes, thereby generating a plurality of units of transformed data from the plurality of units of staged data; and
publish the transformed data to at least one data store after all of the plurality of tasks are completed, thereby ensuring that the published data represent the related data set.

14. The computer program product, as recited in claim 13, wherein the computer program instructions are further operable to cause the at least one computer device to:
assign the tasks to each subset of tasks such that each child process executes approximately a same number of tasks.

15. The computer program product, as recited in claim 13, wherein the computer program instructions are further operable to cause the at least one computer device to, for each of the child processes:
monitor execution of the tasks assigned to the child process; and
if the child process fails to execute all of the tasks assigned to the child process, assign unexecuted ones of the tasks assigned to the child process to another one of the child processes.

16. The computer program product, as recited in claim 13, wherein the computer program instructions are further operable to cause the at least one computer device to, for each of the plurality of child processes:
monitor execution of the tasks assigned to the child process; and
if the child process fails to execute all of the tasks assigned to the child process, invoke a new child process to replace the child process and assign unexecuted ones of the tasks assigned to the child process to the new child process.

17. The computer program product, as recited in claim 13, wherein the computer program instructions are further operable to cause the at least one computer device to:
if execution of the master process terminates before completion, terminate execution of all of the child processes.

18. The computer program product, as recited in claim 13, wherein the computer program instructions are operable to cause the at least one computer device to identify the plurality of tasks by identifying at least one task for transforming each unit of staged data when the unit of staged data becomes available.

19. The computer program product, as recited in claim 13, wherein the computer program instructions are operable to cause the at least one computer device to identify the plurality of tasks after all the units of staged data are available.

20. The computer program product, as recited in claim 13, wherein the related data set is defined with reference to at least one metric selected from the group consisting of a period of time, a geographic region, a business entity, a business analysis, a product, and a group of customers.
